(19) United States
(12) Patent Application Publication
(10) Pub. No.: US 2007/0137936 A1
(43) Pub. Date: Jun. 21, 2007

(54) Lubricant feed state monitoring sensor and lubricant feed state monitoring device

(75) Inventors: Yoshihiro Akechi, Chiba (JP); Shuji Jyoken, Chiba (JP)

Correspondence Address: IP GROUP OF DLA PIPER US LLP, ONE LIBERTY PLACE, 1650 MARKET ST, SUITE 4900, PHILADELPHIA, PA, 19103, US

(73) Assignee: JFE Steel Corporation, Tokyo (JP)

(21) Appl. No.: 10/582,147

(22) PCT Filed: Jan. 9, 2004
(86) PCT No.: PCT/JP04/00106

§ 371 Date: Jun. 7, 2006

(51) Int. Cl. F16N 3/00

(52) U.S. Cl. 184/14

(57) ABSTRACT

A lubricant-feed-state monitoring sensor disposed directly associated with a device fed with oily or fatty lubricant or a lubricant feed pipe for feeding lubricant to the device, for monitoring the feed state of lubricant by detecting the supply of the lubricant to the device, the sensor including a T-shaped member having a lubricant passage connected to the lubricant feed pipe and a detector insertion portion extending substantially vertically from a middle portion of the lubricant passage, into which a detector is inserted; wherein the detector is disposed such that a first end portion of the detector is fixed to a top portion of the detector insertion portion, and a second end portion is positioned in the lubricant passage without restraint, the detector undergoing bending deflection by displacement of the second end portion due to the flow of the lubricant, and the detector having a piezoelectric element that generates voltage by the bending deflection.

### RELATED APPLICATION

This is a §371 of International Application No. PCT/JP2004/000106, with an international filing date of Jan. 9, 2004 (WO 2005/057079 A1, published Jun. 23, 2005), which is based on Japanese Patent Application No. 2003-413887, filed Dec. 11, 2003.

### TECHNICAL FIELD

The present invention relates to sensors and devices for monitoring the feed state of lubricant fed to points to be lubricated such as bearings of rotary machines.

### BACKGROUND

A large number of rotary machines are generally used in production facilities of factories, where a lot of automatic central lubricating devices are used for feeding the bearings of rotary machines and the like with lubricant such as grease at regular intervals. A leading cause of troubles of rotary machines is poor lubrication. Accordingly, it is important to monitor whether lubricant is applied to the respective facilities appropriately.

Known methods for monitoring the feed state of lubricant from automatic central lubricating devices include a method of checking whether lubricant is fed appropriately by counting the number of operations of distributing valves in a specified time using the fact that the distributing valves operate when lubricant is fed at regular intervals.

However, this method cannot provide information on the feed state of lubricant in channels following the distributing valves. Accordingly, poor lubrication due to the breakage or clogging of lubricant feed pipes from the distributing valves through bearings cannot be monitored by this method.

Another known method is a method of checking the feed state of lubricant from distributing valves to object mechanical components to be fed with the lubricant such as bearings using pressure sensors mounted to lubricant feed pipes adjacent to lubricating points. Known pressure sensor methods include a method of comparing the pressure of lubricant in lubricant feed pipes which is measured with the pressure sensors and a predetermined pressure with a controller and determining whether no lubricant is fed or whether the pressure sensor abnormal from the comparison results and generating an alarm as disclosed in, for example, JP-A-2001-164916.

However, these pressure sensor methods need to mount a pressure sensor to every lubricant feed pipes adjacent to lubricant points and to supply power to all the pressure sensors. Accordingly, if several thousand monitor points of a production factory are configured by the pressure sensor systems, a large-scale monitoring system will be required, thus increasing installation cost.

Another known method is a method in which piezoelectric elements are disposed in contact with the channel of lubricant, the pulse pressure in the channel is applied to the piezoelectric elements, and the resultant electrical charge is converted to voltage to determine the lubricant feed state as disclosed in, for example, JP-A-1-197623.

However, the method of applying the pulse pressure of lubricant to the piezoelectric elements in contact with the channel cannot provide sufficiently strong signals. In other words, the method cannot provide practical output enough to know the lubricant feed state, thus posing the problem of lacking reliability.

### SUMMARY

A low-price lubricant-feed-state monitoring sensor and a lubricant-feed-state monitoring device capable of reliably monitoring the feed state of lubricant to be fed to portions such as bearings of rotary machines in the vicinity of the lubricating points is disclosed.

A lubricant-feed-state monitoring sensor disposed directly to a device that needs to be fed with oily or fatty lubricant or to a lubricant feed pipe for feeding lubricant to the device, for monitoring the feed state of lubricant by detecting the feed of the lubricant to the device is disclosed. The sensor includes a detection member disposed in such a manner that a first end is fixed and a second end is positioned in the flow of lubricant produced when the lubricant is fed, the detection member undergoing bending deflection by the displacement of the second end due to the flow of the lubricant, and the detection member having a piezoelectric element that generates voltage by the bending deflection.

There is provided a lubricant-feed-state monitoring device, including: a sensor disposed directly to a device that needs to be fed with oily or fatty lubricant or to a lubricant feed pipe for feeding lubricant to the device, for monitoring the feed state of lubricant by detecting the feed of the lubricant to the device; and a count unit that counts the number of feedings of lubricant to the device on the basis of a detection signal output from the sensor. The sensor includes a detection member disposed in such a manner that a first end is fixed and a second end is positioned in the flow of lubricant produced when the lubricant is fed, the detection member undergoing bending deflection by the displacement of the second end due to the flow of the lubricant, the detection member having a piezoelectric element that generates voltage by the bending deflection; and the counter unit counts the number of feedings of lubricant on the basis of a voltage pulse of a detection signal output as voltage from the piezoelectric element.

A sensor having a piezoelectric element is disposed directly to a device that needs to be fed with oily or fatty lubricant or to a lubricant feed pipe for feeding lubricant to the device. Thus there is no need to have a driving power source, so that the lubricant feed state can be monitored at low cost. Furthermore, a detection member having a piezoelectric element is disposed in such a manner that a first end is fixed and a second end is positioned in the flow of lubricant. produced when the lubricant is fed, so that the detection member undergoes bending deflection by the displacement of the second end due to the flow of the lubricant, by which the piezoelectric element generates voltage. This structure can output voltage larger than that of detecting pulsed voltage of lubricant. Accordingly, the lubricant feed state can be monitored reliably in the vicinity of lubricating points.

The detection member may further include a coating member made of a flexible material that coats the piezoelectric element. The detection member may further include a reinforcing member that sandwiches the piezoelectric element, and a coating member made of a flexible material that coats the reinforcing member.

The sensor may be such a structure that further includes a T-shaped member having a lubricant passage connected to the lubricant feed pipe and a detection member insertion portion extending vertically from the middle of the lubricant passage, into which the detection member is inserted. The first end of the detection member may be fixed to the top of the detection member insertion portion, and the second end may be positioned in the lubricant passage without restraint.

A lubricant-feed-state monitoring sensor according to the invention includes: a member that undergoes bending deflection by the lubricant flow when the lubricant is fed; signal conversion means that senses the strain of the member generated due to the bending deflection and converts the strain to an electrical signal; and pipe joint means for connecting to the lubricant feed pipe disposed so that the member undergoes the bending deflection due to the lubricant flow, the pipe joint means having a retaining seal structure for retaining the disposed member and preventing the leakage of the lubricant.

In the lubricant-feed-state monitoring device, the pipe joint means may be configured of one joint of a T-shaped pipe joint, a Y-shaped pipe joint, a cross pipe joint, an elbow, and a bend.

The lubricant-feed-state monitoring device may include the counter unit that counts the number of feedings of lubricant on the basis of an electrical signal converted from the bending strain of the member when the lubricant is fed, the signal being output from the signal conversion means.

In the lubricant-feed-state monitoring device, the counter unit may be disposed rotatably to the pipe joint means.

In the lubricant-feed-state monitoring device, the counter unit may be disposed detachably from the pipe joint means.

In the lubricant-feed-state monitoring device, the counter unit may connect to the pipe joint member via a flexible tube.

In the lubricant-feed-state monitoring device, the counter unit may include clamp means or attracting means.

The lubricant-feed-state monitoring device may further include date setting means capable of setting and displaying date including at least month and day.

In the lubricant-feed-state monitoring device, the counter unit may include reset means for resetting the count.

In the lubricant-feed-state monitoring device, the counter unit may include a timer unit that generates signals at regular intervals and an alarm unit that generates an alarm when the number of lubricant feedings detected in the interval is smaller than a predetermined number of lubricant feedings.

In the lubricant-feed-state monitoring device, the counter unit may include an alarm unit that takes in a signal indicative of the operation of a distributing valve upstream in the lubricant feed pipe as a lubricant feed signal, and generates an alarm when there is no output indicative of lubricant feeding from the lubricant-feed-state monitoring device or when the output is small in a given period of time after the lubricant feed signal has been detected.

In the lubricant-feed-state monitoring device, the counter unit may include an alarm unit that takes in a start-up signal of a lubricant feed pump that pumps lubricant to the lubricant feed pipe as a lubricant feed signal, and generates an alarm when there is no output indicative of lubricant feeding from the lubricant-feed-state monitoring device or when the output is small in a given period of time after the lubricant feed signal has been detected.

In the lubricant-feed-state monitoring device, the alarm unit may generate an alarm by at least one of sound, light, and mechanically retained indication.

In the lubricant-feed-state monitoring device, the counter unit may include a radio unit that takes in at least one of the signal output from the signal conversion means, the count signal indicative of the number of lubricant feedings, the operation signal of the distributing valve, the start-up signal of the lubricant feed pump, and the alarm signal from the alarm unit and transmits the signal by radio.

In the lubricant-feed-state monitoring device, the counter unit may include a data collection unit that takes in at least one of the signal output from the signal conversion means, the count signal indicative of the number of lubricant feedings, the operation signal of the distributing valve, the start-up signal of the lubricant feed pump, and the alarm signal from the alarm unit; and a transmission unit that transmits the collected data via cable, radio, telephone line, or LAN.

In the lubricant-feed-state monitoring device, the member may be a piezoelectric element serving also as the signal conversion means.

In the lubricant-feed-state monitoring device, the member may be formed in such a manner that a piezoelectric element serving also as the signal conversion means is coated with a coating member.

In the lubricant-feed-state monitoring device, the member may be formed in such a manner that a piezoelectric element serving also as the signal conversion means and a contact member that is in contact with the piezoelectric element are coated with a coating member.

In the lubricant-feed-state monitoring device, the signal conversion means may be a strain gauge.

In the lubricant-feed-state monitoring device, the member may include the strain gauge.

There is provided a method of monitoring the feed state of lubricant to a device that needs to be fed with the lubricant to be lubricated using a sensor that is mounted to the device or a lubricant feed pipe connected to the device. The method includes: disposing the sensor so as to undergo bending deflection by the lubricant flow when the lubricant is fed; converting the strain generated by the sensor owing to the bending deflection due to the lubricant flow to an electrical signal; counting the number of lubricant feedings to the device that needs to be fed with the lubricant on the basis of the electrical signal; and when the counted number of lubricant feedings falls below a predetermined number of lubricant feedings in a given period of time, determining that the lubricant feed state is abnormal.

There is provided a method of monitoring the feed state of lubricant to a device that needs to be fed with the lubricant using a sensor that is mounted to the device or a lubricant feed pipe connected to the device. The method includes: disposing the sensor so as to undergo bending deflection by the lubricant flow when the lubricant is fed; converting the strain generated by the sensor owing to the bending deflection due to the lubricant flow to an electrical signal; measuring the peak voltage of the electrical signal by peak hold processing of the electrical signal; and when the peak voltage comes out of a predetermined range, determining that the lubricant feed state is abnormal.

In the method of monitoring the feed state of lubricant, a lower threshold and a upper threshold are set for the peak voltage in advance; and when the peak voltage falls below the lower threshold, it is determined that the amount of lubricant has decreased or stopped, and when the peak voltage exceeds the upper threshold, it is determined that the part downstream from the sensor is clogged.

In the method of monitoring the feed state of lubricant, a piezoelectric element is used for the sensor.

In the method of monitoring the feed state of lubricant, when a piezoelectric element is used as the sensor, the capacitance of the sensor is measured after the monitoring of the lubricant feed state has been started, and when the capacitance becomes smaller than a predetermined threshold, it is determined that the sensor is abnormal, and abnormality owing to the abnormal sensor is removed from the determination on abnormality based on the count of lubricant feedings, on the basis of the determination on the sensor abnormality.

In the method of monitoring the feed state of lubricant, when a piezoelectric element is used as the sensor, the capacitance of the sensor is measured after the monitoring of the lubricant feed state has been started, and when the capacitance becomes smaller than a predetermined threshold, it is determined that the sensor is abnormal, and abnormality owing to the abnormal sensor is removed from the determination on abnormality based on the peak voltage, on the basis of the determination on the sensor abnormality.

In the method of monitoring the feed state of lubricant, a piezoelectric element coated with a coating member is used as the sensor.

In the method of monitoring the feed state of lubricant, a piezoelectric element coated with a coating member and a contact member in contact with the piezoelectric element are used as the sensor.

In the method of monitoring the feed state of lubricant, a strain gauge is used as the sensor.

### BRIEF DESCRIPTION OF THE DRAWINGS

FIG. 1 is a sectional view showing the structure of a lubricant-feed-state monitoring sensor.

FIG. 2 is a sectional view showing the structure of a detection member of the lubricant-feed-state monitoring sensor of FIG. 1.

FIG. 3 is a schematic diagram of a structural example in which the lubricant-feed-state monitoring sensor is incorporated in a lubricant feed circuit.

FIG. 4 is a diagram showing the output waveform of the lubricant-feed-state monitoring sensor.

FIG. 5A is a schematic diagram of a system used in an experiment for confirming selected advantages.

FIG. 5B is a schematic diagram of a system used in an experiment for confirming selected advantages.

FIG. 6 is a diagram showing the output waveform of a lubricant-feed-state monitoring sensors according to one example and a comparative example.

FIG. 7 is a schematic diagram of a lubricant-feed-state monitoring device.

FIG. 8 is a schematic diagram of another lubricant-feed-state monitoring device.

FIG. 9 is a schematic diagram of yet another lubricant-feed-state monitoring device.

FIG. 10 is a schematic diagram of still another lubricant-feed-state monitoring device.

FIG. 11 is a schematic diagram of a further lubricant-feed-state monitoring device.

FIG. 12 is a schematic diagram of a still further lubricant-feed-state monitoring device.

FIG. 13 is a sectional view of another structure of the lubricant-feed-state monitoring sensor.

FIG. 14 is a sectional view of another structure of the lubricant-feed-state monitoring sensor.

FIG. 15 is a schematic diagram of a structural example in which the lubricant-feed-state monitoring sensor is incorporated in a lubricant feed circuit.

FIG. 16 is a schematic diagram of another structural example in which the lubricant-feed-state monitoring sensor is incorporated in a lubricant feed circuit.

FIG. 17 is a simplified sectional view of the structure of a lubricant-feed-state monitoring sensor.

FIG. 18 is a simplified sectional view of the structure of another lubricant-feed-state monitoring sensor.

FIG. 19 is a simplified sectional view of the structure of yet another lubricant-feed-state monitoring sensor.

FIG. 20 is a sectional view of the structure of still another lubricant-feed-state monitoring sensor.

FIG. 21 is a sectional view of a detection member viewed from the side.

FIG. 22 is a diagram showing the waveform output from a lubricant-feed-state monitoring sensor using a strain detecting element.

FIG. 23A is a simplified sectional view of a lubricant-feed-state monitoring device.

FIG. 23B is a simplified sectional view of another lubricant-feed-state monitoring device.

FIG. 23C is a simplified sectional view of yet another lubricant-feed-state monitoring device.

FIG. 24 is a simplified sectional view of still another lubricant-feed-state monitoring device.

FIG. 25A is a diagram showing a state in which a counter unit is mounted to a lubricant feed pipe.

FIG. 25B is a diagram showing a state in which the counter unit is mounted to the lubricant feed pipe.

FIG. 26A is a diagram showing a state in which the counter unit is mounted on a pipe joint.

FIG. 26B is a diagram showing a state in which the counter unit is mounted on a pipe joint.

FIG. 26C is a diagram showing a state in which the counter unit is mounted on a pipe joint.

FIG. 27 is a simplified sectional view of a lubricant-feed-state monitoring device.

FIG. 28 is a schematic diagram of a structural example in which the lubricant-feed-state monitoring device is incorporated in the lubricant feed circuit.

FIG. 29 is a diagram of a date setting mechanism.

FIG. 30 is a simplified sectional view of a lubricant-feed-state monitoring device.

FIG. 31 is a block diagram of the structure of a counter unit of a lubricant-feed-state monitoring device.

FIG. 32 is a block diagram of the structure of another counter unit of a lubricant-feed-state monitoring device.

FIG. 33 is a block diagram of the structure of a counter unit of a lubricant-feed-state monitoring device.

FIG. 34 is a block diagram of the structure of a counter unit of a lubricant-feed-state monitoring device.

FIG. 35 is a block diagram of the structure of a counter unit of a lubricant-feed-state monitoring device.

FIG. 36 is a block diagram of the structure of another counter unit of a lubricant-feed-state monitoring device.

FIG. 37 is a diagram showing the structure of a mechanical alarm display unit.

FIG. 38A is a diagram showing the structure of a mechanical alarm display unit.

FIG. 38B is a diagram showing the structure of a mechanical alarm display unit.

FIG. 39 is a graph of a method of monitoring a lubricant feed state, showing an example of changes in the number of lubricant feedings with time per fixed period which are measured using a counter unit.

FIG. 40 is a graph showing the relationship between the cumulative numbers of lubricant feedings and time.

FIG. 41 is a graph of a method of monitoring a lubricant feed state, showing an example of changes in sensor output with time of the peak voltage which were measured using a device which can perform a peak hold processing.

FIG. 42 is an explanatory diagram of a test screen of an oscilloscope on which a waveform output by a sensor is displayed without peak hold processing.

FIG. 43A shows changes in capacitance due to the breakage of the distal end of the sensor of a lubricant-feed-state monitoring sensor having a piezoelement as a sensor.

FIG. 43B is a graph showing changes in capacitance due to the breakage of the distal end of the sensor of a lubricant-feed-state monitoring device having a piezoelement as a sensor.

### DETAILED DESCRIPTION

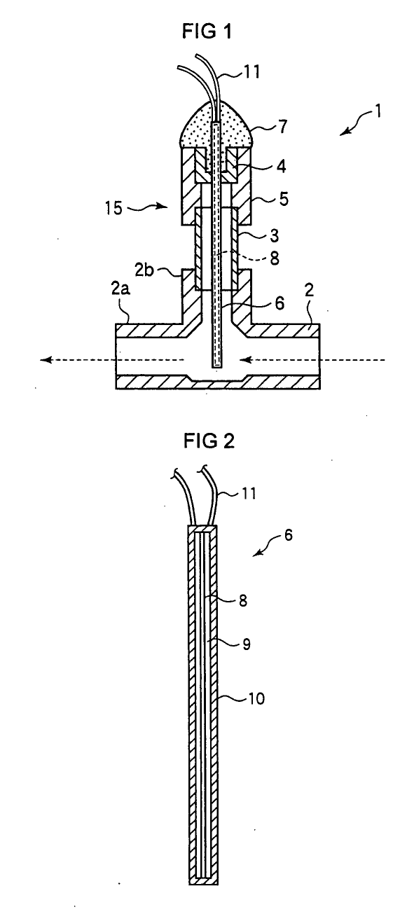

FIG. 1 is a sectional view showing the structure of a lubricant-feed-state monitoring sensor.

The lubricant-feed-state monitoring sensor 1 has the following structure. A nipple 3 connects to a joint portion 2b of a T-shaped pipe joint 2. The T-shaped pipe joint 2 is to be connected to a lubricant feed pipe for feeding oily or fatty lubricant, such as grease, to a lubricating point, such as a bearing of a rotary machine. A socket 5, in which a plug 4 is inserted, connects to the opposite side of the nipple 3. A plate-like detection member 6 having a piezo element (piezoelectric element) 8 is inserted through an opening of the plug 4 into the T-shaped pipe joint 2. The plug 4 and the socket 5 are screwed up. The nipple 3 and the socket 5, and the nipple 3 and the joint portion 2b are also screwed up.

A main pipe 2a of the T-shaped pipe joint 2 connects to a lubricant feed pipe (not shown), thus functioning as a lubricant passage. The joint portion 2b extends vertically from the center of the main pipe 2a. The joint portion 2b, the nipple 3, the plug 4, and the socket 5 constitute a detection member insertion portion 15 into which a detection member 6 is to be inserted. In place of the T-shaped pipe joint 2, a joint in which a Y-shaped pipe joint or a cross joint having a plug may be used. However, it is desirable to use the T-shaped pipe joint 2 because of ease of configuration.

The nipple 3 and the socket 5 are not always needed because they are provided to adjust the length of the detection member insertion portion 15 to the length of the detection member 6. However, as will be described below, it is desirable to have the nipple 3 and the socket 5 because the detection member 6 needs to have some length to improve the sensitivity.

The upper end of the detection member 6 is fixed such that the top of the plug 4 is fixed with a resin 7, thereby preventing the leakage of lubricant from the T-shaped pipe joint 2. The lower end of the detection member 6 is positioned without restraint in the main pipe 2a functioning as a lubricant passage. Accordingly, when lubricant is fed and flows in the main pipe 2a, the lower end of the detection member 6 is displaced by the flow of the lubricant to undergo bending deflection. The piezo element 8 thus develops electrical charge by the bending deflection to generate voltage.

As shown in the sectional view of FIG. 2, the detection member 6 has a structure in which a longitudinal rectangular piezo element 8 is sandwiched by reinforcing plates 9, the whole of which is covered with a flexible coating member 10.

The piezo element 8 has an end electrode on both sides. The end electrodes connect to a lead 11 for extracting the voltage generated by the piezo element 8 by soldering or the like. In other words, when the piezo element 8 is subjected to bending stress associated with the flow of lubricant to be strained, voltage is generated on both ends of the lead.

For the piezo element 8, a bending type, i.e., those capable of generating voltage by bending deflection, as described above, is used, which may be either a monomorph type composed of one piezo element or a bimorph type composed of two piezo elements. When the bimorph piezoelectric element is bent by a force F, one of the piezo elements extends and the other element contracts, so that both of the two elements generate electrical charge, thereby producing large output. The piezo element 8 may be composed of plate-like three or more piezo elements. The piezo element 8 is preferably made of piezoelectric ceramic or polymeric piezoelectric film provided that it has a piezoelectric characteristic. Among them, piezoelectric ceramic having a high output voltage is desirable. The piezo element 8 may be in any shape, such as a rod or a half cylinder provided that it has a length sufficient to receive the bending stress from the lubricant flow. However, it preferably has the shape of an elongated rectangle in view of convenience in handling and manufacturing cost.

The reinforcing plate 9 is provided to prevent the breakage of the piezo element 8 due to bending stress. The reinforcing plate 9 may be made of, so long as a material thereof can prevent the breakage of the piezo element 8 due to a specified bending stress, metal such as iron and polymeric materials such as plastic provided that they are isolated from the piezo element 8. The reinforcing plate 9 may be disposes either on both sides of the piezo element 8 or on one side.

The coating member 10 is for protecting the piezo element 8 and the reinforcing plate 9 altogether, and if the piezo element 8 is broken, for preventing the broken pieces from entering the lubricant to cause abnormality of facilities. The coating member 10 is particularly effective when the piezo element 8 is formed of weak ceramic. It is preferable that the coating 10 be made of a flexible material having a sufficient protective function, such as resin. For example, it is preferable to use heat shrinkable film.

The reinforcing plate 9 and the coating member 10 may have a multilayer structure, depending on the material and the condition of using the piezo element 8. The reinforcing plate 9 and the coating member 10 are not always needed. The piezo element 8 may be directly covered with the coating member 10 to form the detection member 6 without using the reinforcing plate 9, or alternatively, the piezo element 8 sandwiched by the reinforcing plates 9 may be used as the detection member 6. When the piezo element 8 has sufficient strength and toughness, the detection member 6 may be composed of only the piezo element 8. However, it is preferable to provide the coating member 10 because it has the function of providing strong moisture resistance and electrical insulation.

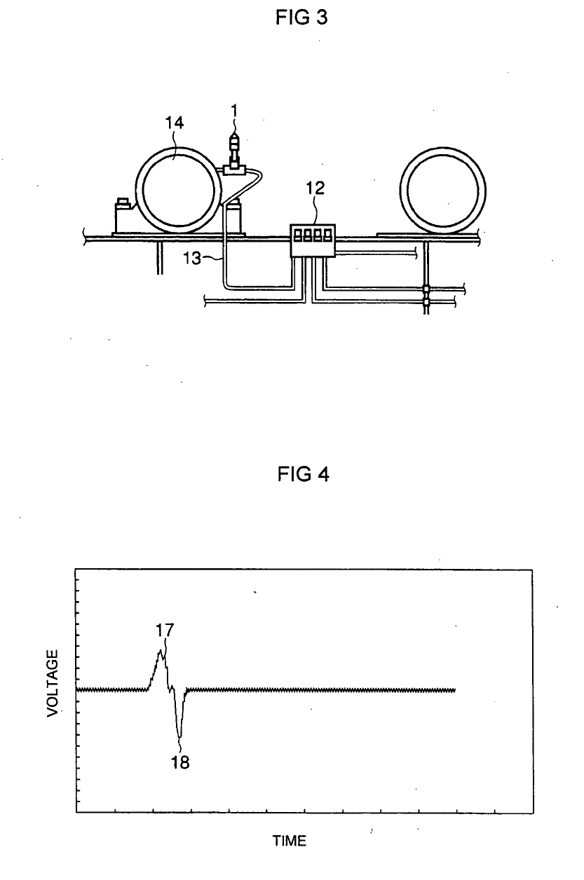

FIG. 3 shows a structural example in which the lubricant-feed-state monitoring sensor 1 is incorporated in a lubricant feed circuit.

The lubricant-feed-state monitoring sensor 1 is incorporated in part of the lubricant feed circuit configured of an automatic central lubricating device that feeds lubricant at regular intervals. Specifically, the lubricant-feed-state monitoring sensor 1 is disposed in a midpoint of a lubricant feed pipe 13 branching from a distributing valve 12. To monitor the feeding of lubricant to a lubricating point, it is preferable to dispose the lubricant-feed-state monitoring sensor 1 close to a bearing 14 which is a lubricating point, or to the bearing 14 itself.

In the lubricant-feed-state monitoring sensor thus constructed, when lubricant is fed through the lubricant feed pipe 13 to a lubricating point, the flow of lubricant generates in the main pipe 2a of the T-shaped pipe joint 2 in the direction indicated by the arrow shown in FIG. 1. Then, the detection member 6 is bent downstream, with the portion fixed by the resin 7 as the fulcrum. As a result, opposite electrical charges generate on the front and back surfaces of the piezo element 8 to generate voltage at the both ends of the lead 11. Thus the feed state of lubricant can be grasped by detecting the voltage.

FIG. 4 shows the output waveform at that time. The axis of ordinate indicates the voltage generated in the lead 11, and the axis of abscissa indicates the elapsed time. As shown in FIG. 4, when the intermittent pressure flow of lubricant is applied to the detection member 6 to cause bending deflection, a pulsed voltage 17 is generated. When the flow of lubricant stops, the detection member 6 is recovered to the initial state by the elasticity of the piezo element 8 and the reinforcing plate 9. At that time, the bending strain applied is reduced to generate a reverse-polarity pulsed voltage 18.

In this way, a pair of positive and negative voltage pulses is generated by the intermittent lubricant flow to form a waveform with little noise, as shown in FIG. 4. Accordingly, the longer the detection member 6, the stronger the bending strain becomes, thus generating higher voltage.

Since the lubricant-feed-state monitoring sensor according to this embodiment is designed on the above-described principle using the piezo element 8, it generates high voltage at the level that needs no special amplifying process and noise rejecting process in signal processing. Also, the use of the piezo element 8 allows the lubricant feed state to be grasped without using a power source. Consequently, a compact and low-price lubricant-feed-state monitoring sensor can be provided.

According to the principle, since the bending strain of the detection member 6 increases with an increasing amount of lubricant, the peak of the voltage 17 generated also increases. Accordingly, it can be determined that, when the voltage 17 is higher than a specified voltage, a sufficient amount of lubricant is being fed; when the voltage 17 is lower than that, the amount of fed lubricant is insufficient.

Furthermore, the upper end of the detection member 6 having the piezo element 8 is fixed, and the lower end is disposed so as to be positioned in the flow of lubricant which is formed when lubricant is fed so that the flow of the lubricant causes displacement at the lower end to generate bending deflection, thereby casing the piezo element 8 to generate voltage. Accordingly, this structure can provide substantially higher output than that of the case of detecting the pulsed pressure of lubricant, as in Patent Document 2, thus allowing reliable monitoring of the lubricant feed state in the vicinity of lubricating points.

An experiment in which the above-described effects were confirmed will now be described.

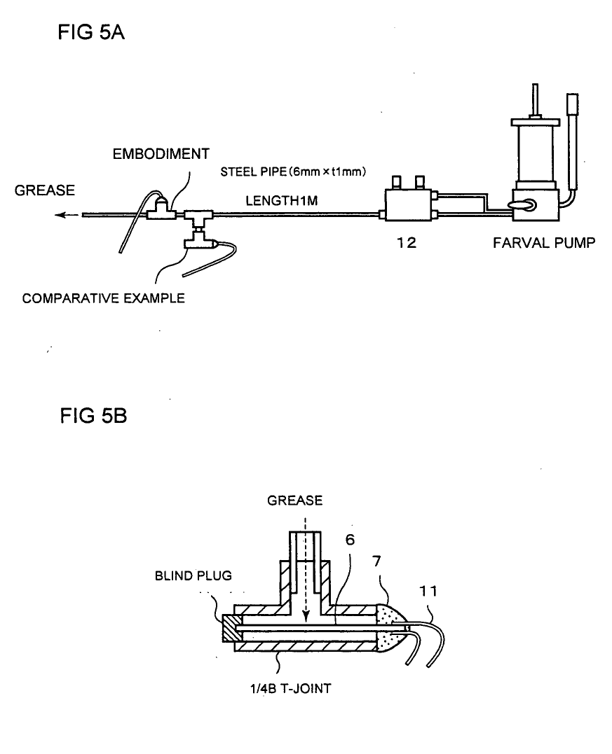

A lubricant or grease feeding unit, shown in FIG. 5A, was prepared, to which the lubricant-feed-state monitoring sensor according to the structure shown in FIG. 1 and a comparative lubricant-feed-state monitoring sensor shown in FIG. 5B were mounted. Specifically, the lubricant-feed-state monitoring sensor was mounted in such a manner that the detection member is vertically cantilevered in a T-shaped pipe joint (¼B) with one end being fixed, while the comparative lubricant-feed-state monitoring sensor was disposed horizontally in a T-shaped pipe joint (¼B) with the both ends being fixed, like the sensor disclosed in JP-A-1-197623. A piezoelectric element made of a 5×60×0.5 mm lead-zirconate-titanate-based ceramic was used as a detection member, over which a heat shrinkable film (known under the trade name of Sumitube) was coated.

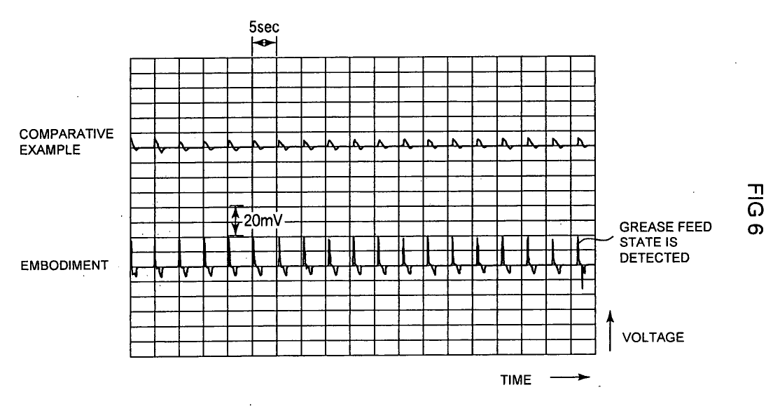

The grease serving as lubricant was intermittently fed with a farval pump. FIG. 6 shows the state of the detected voltage at that time. As shown in FIG. 6, for the comparative example, a pulse as low as a few millivolts was given by the feeding of grease; for the embodiment, a pulse exceeding 20 millivolts was given. This shows that the structure of the invention allows the lubricant feed state to be monitored more reliably.

The structure of a monitoring device for monitoring the lubricant feed state using the lubricant-feed-state monitoring sensor 1 will be described.

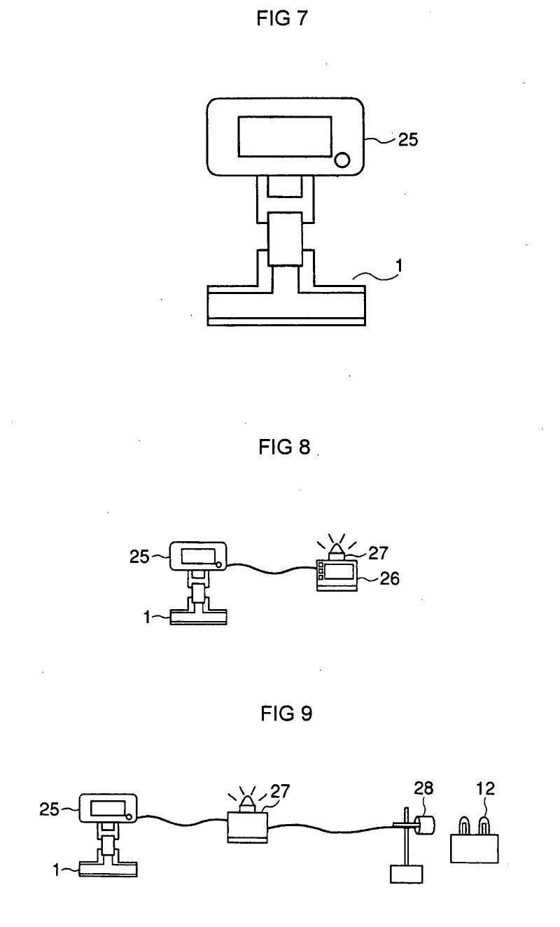

FIG. 7 is a schematic diagram of a lubricant-feed-state monitoring device.

The lubricant-feed-state monitoring device according to the first embodiment is a device in which a counter unit 25 is mounted to the lubricant-feed-state monitoring sensor 1. The lead 11 of the lubricant-feed-state monitoring sensor 1 and the input terminal of the counter unit 25 connect to each other.

Every time lubricant flow is generated, the detection member 6 detects the flow, and the counter unit 25 counts the number of lubricant feedings and displays the count. The initial count of the counter unit 25 is recorded, and after a given period of time, the count displayed on the counter unit 25 is checked. The initial count is subtracted from the displayed count to determine the number of lubricant feedings in the period of time. Here, when no count is displayed, it indicates that no lubricant is fed or little lubricant is fed. Accordingly, it can be determined whether lubricant is normally fed by comparing the calculation with the number of feedings of lubricant to be fed in a given period of time.

In this case, since the piezo element 8 is used as the detection member 6, there is no need to have a power supply for feeding the detection member 6 but only the counter unit 25 requires power. Accordingly, the use of a compact battery for the counter unit 25 can decrease the size and cost of the entire device.

FIG. 8 is a schematic diagram of a lubricant-feed-state monitoring device. The lubricant-feed-state monitoring sensor 1 is provided with the counter unit 25, a timer unit 26, and an alarm unit 27.

An arithmetic unit (not shown) determines whether lubricant has been fed in a given period of time from the number of lubricant feedings counted by the counter unit 25 and time information from the timer unit 26. When no or little lubricant has been fed in a given period of time, the alarm unit 27 generates an alarm.

A poor lubricant feed state can be monitored and a failure alarm can be generated by a relatively small device. Accordingly, the counter unit 25, the timer unit 26, and the alarm unit 27 may either be integrated to one or separated and connected to one another via a signal line.

The alarm unit 27 may generate an alarm with light or sound, or alternatively, may electronically display an alarm or mechanically switch to display an alarm.

FIG. 9 is a schematic diagram of a lubricant-feed-state monitoring device. The monitoring device includes the lubricant-feed-state monitoring sensor 1, the counter unit 25, the alarm unit 27, and a distributing-valve displacement sensor 28.

The distributing-valve displacement sensor 28 detects the operation of the distributing valve 12, and takes in the timing at which the distributing valve 12 is activated as a lubricant feed timing. When the count of the counter unit 25 does not increase in a given period of time after the distributing valve 12 is activated, it is determined that lubricant feeding is faulty, and the alarm unit 27 generates an alarm of it.

The monitoring device has the distributing-valve displacement sensor 28, in place of the timer unit 26 of the foregoing to detect the displacement of the distributing valve, thereby monitoring the lubricant feed state when the distributing valve 12 is activated. Accordingly, this monitoring device can detect abnormality faster than using the timer unit 26.

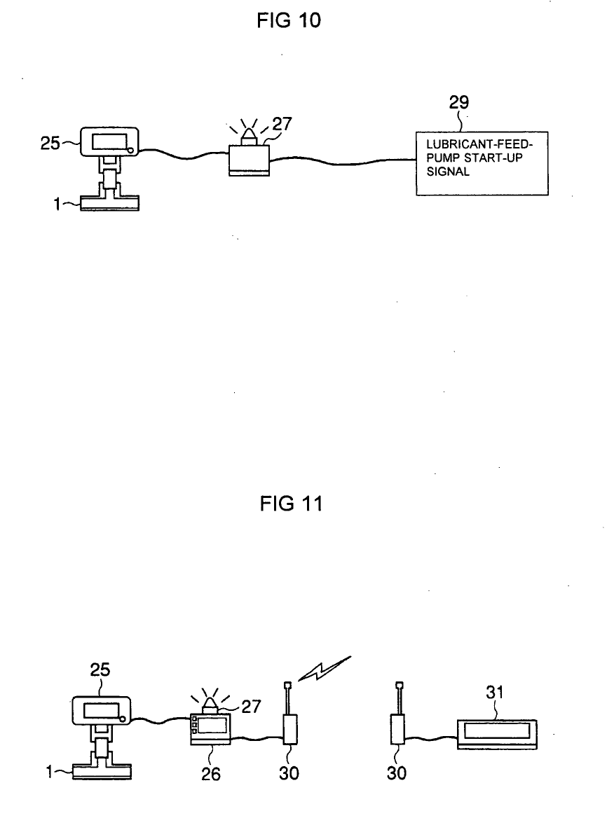

FIG. 10 is a schematic diagram of a lubricant-feed-state monitoring device. The monitoring device includes the lubricant-feed-state monitoring sensor 1, the counter unit 25, the alarm unit 27, and a lubricant-feed-pump start-up signal 29.

When the count of the counter unit 25 does not increase in a specified time after the lubricant-feed-pump start-up signal 29 is turned on, it is determined that the lubricant feeding is faulty, and the alarm unit 27 generates an alarm about it.

The monitoring device has the lubricant-feed-pump start-up signal 29 in place of the timer unit 26 of the foregoing embodiment to detect the ON state of the lubricant-feed-pump start-up signal 29, thereby monitoring the lubricant feeding state. Accordingly, this monitoring device can detect abnormality faster than using the timer unit 26.

FIG. 11 is a schematic diagram of a lubricant-feed-state monitoring device. The monitoring device of this embodiment includes a radio unit 30 and a data collection unit 31 in addition to the monitoring device of the first or other embodiments.

With the monitoring device, the user can collect data on the lubricant feed state of facilities that are difficult to access in operation for safety reasons, and monitor it. Here, the data being collected may either be the count or the determination on the lubricant feed state.

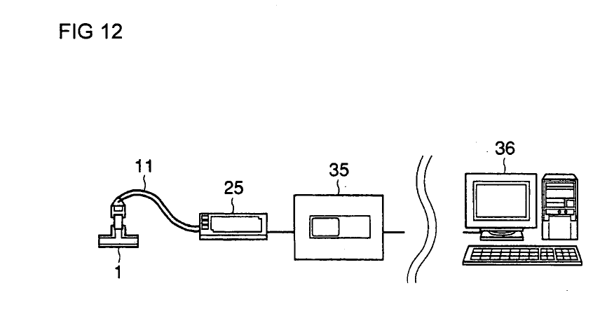

FIG. 12 is a schematic diagram of a lubricant-feed-state monitoring device according to another embodiment. The monitoring device of this embodiment is configured as an online monitoring system. The lubricant-feed-state monitoring sensor 1 connects to the counter unit 25 and a data-collection monitoring device 35 via the lead 11, and transmits data on the lubricant feed state to a personal computer 36 via cable, radio, telephone line, LAN, etc. (not shown).

This structure allows, for particularly important facilities, centralized continuous monitoring of the lubricant feed state by remote control. The online monitoring is not limited to the configuration shown in FIG. 12, but may be a configuration including the data-collection monitoring device 35 and the personal computer 36 in combination with the foregoing embodiments, in which the date generated in the embodiments can be monitored using the data-collection monitoring device 35. The signal output from the lubricant-feed-state monitoring sensor 1 can be connected directly to the data-collection monitoring device 35.

The lubricant-feed-state monitoring devices monitor whether a specified amount or more of lubricant has been fed using the lubricant-feed-state monitoring sensor 1 disposed in lubricating points lubricated or lubricant feed pipes. Thus, monitoring devices are provided with various functions necessary and sufficient to monitor the lubricant feed state in various applications by the combination of the lubricant-feed-state monitoring sensor 1 and various necessary components and devices as in the foregoing embodiments. This allows monitoring the lubricant feed state of lubricating points or the vicinity of the lubricating points, thus preventing initial failure due to poor lubricant feeding.

The structures described herein are not limited to the foregoing structures, but may be modified variously. For example, although grease is used as lubricant in the foregoing embodiments, other various oily and fatty lubricants such as lubricant oil can be used. Although the foregoing give examples in which the device is applied to an automatic central lubricating device, the device can also be applied to manual lubricating systems.

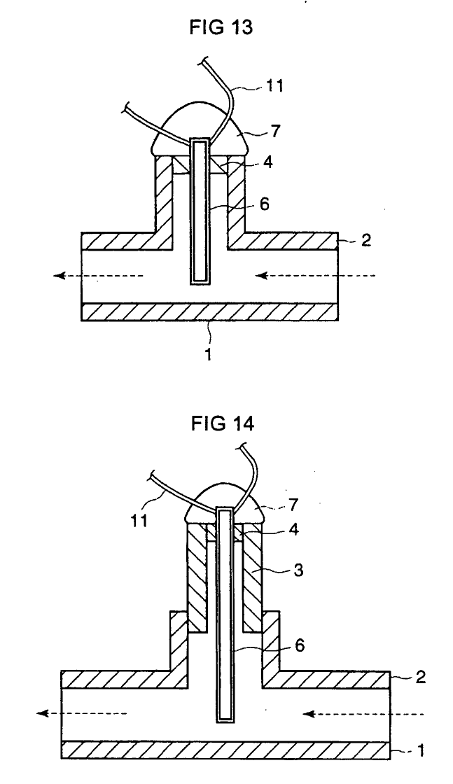

As shown in FIG. 13, the lubricant-feed-state monitoring sensor 1 may have a structure in which the plug 4 is inserted directly in the top of the T-shaped pipe joint 2, and the detection member 6 is inserted into the T-shaped pipe joint 2 through an opening in the plug 4, and the top of the plug 4 is fixed with the resin 7 to fix one end of the detection member 6 and to prevent the leakage of lubricant from the T-shaped pipe joint 2.

The structure shown in FIG. 14 is also possible in which the nipple 3 in which the plug 4 is inserted is connected to the joint portion of the T-shaped pipe joint 2, and the detection member 6 is inserted into the T-shaped pipe joint 2 through the opening of the plug 4, and the top of the plug 4 is fixed with the resin 7 to fix one end of the detection member 6 and to prevent the leakage of lubricant from the T-shaped pipe joint 2.

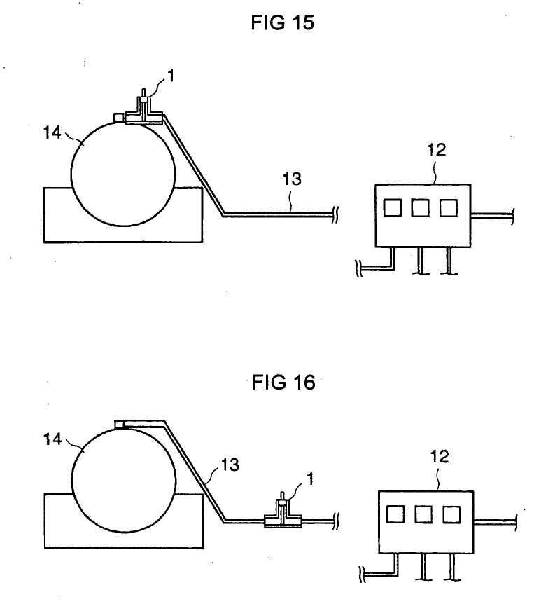

FIG. 15 is a schematic diagram of in which the lubricant-feed-state monitoring sensor is incorporated in a lubricant feed circuit.

The lubricant-feed-state monitoring sensor 1 is incorporated in part of a lubricant feed circuit configured of an automatic central lubrication device that feeds lubricant at regular intervals. Specifically, the lubricant-feed-state monitoring sensor 1 is disposed in a midpoint of the lubricant feed pipe 13 branching from the distributing valve 12. To monitor the feeding of lubricant to a lubricating point, it is preferable to dispose the lubricant-feed-state monitoring sensor 1 close to the bearing 14 which is a lubricating point, or to the bearing 14 itself.

However, it is sometimes difficult to dispose the lubricant-feed-state monitoring sensor 1 in the vicinity of the bearing 14 under the environments of the site in which the facility is placed. In this case, as shown in FIG. 16, it is preferable to dispose the lubricant-feed-state monitoring sensor 1 in a position where breakage can hardly occur.

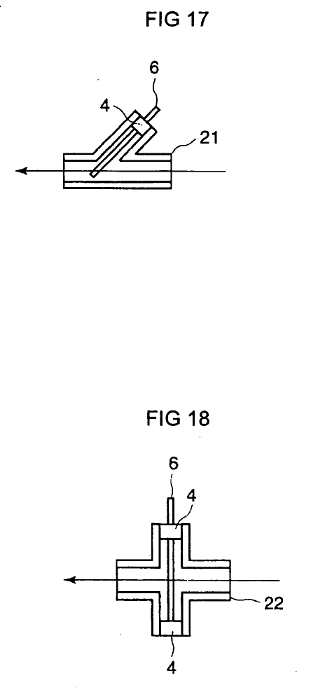

FIG. 17 is a simplified sectional view of the structure of a lubricant-feed-state monitoring sensor according to another embodiment of the invention.

The lubricant-feed-state monitoring sensor includes a Y-shaped pipe joint 21 in place of the T-shaped pipe joint 2 in the lubricant-feed-state monitoring sensors.

The height of the lubricant-feed-state monitoring sensor can be reduced, thus offering the advantage that the monitoring sensor can be disposed in a narrow space that may interfere with other devices or apparatus.

FIG. 18 is a simplified sectional view of the structure of a lubricant-feed-state monitoring sensor.

This lubricant-feed-state monitoring sensor includes a cross-shaped pipe joint 22 in place of the T-shaped pipe joint 2 in the lubricant-feed-state monitoring sensor according to the first embodiment. The cross-shaped pipe joint 22 has the plugs 4 inserted into two ends perpendicular to the flow. The planar detection member 6 having a sensing element is inserted in the cross-shaped pipe joint 22 through an opening in one of the plugs 4, and is supported by the plug 4 on both ends.

The detection member 6 passes through the lubricant feed pipe 13 and retained on the both sides. Thus, the height of one side can be reduced.

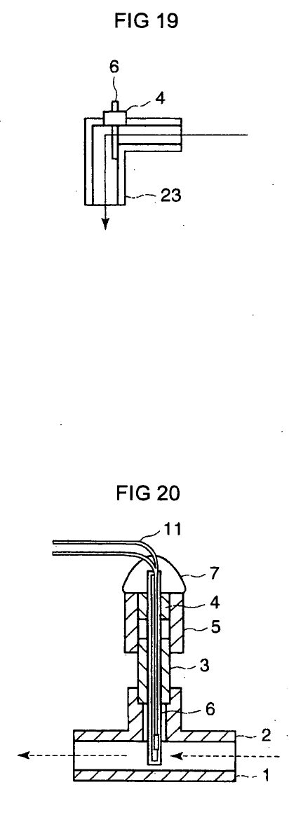

FIG. 19 is a simplified sectional view of the structure of a lubricant-feed-state monitoring sensor.

This lubricant-feed-state monitoring sensor includes an elbow 23 in place of the T-shaped pipe joint 2 in another of the lubricant-feed-state monitoring sensors.

This lubricant-feed-state monitoring sensor can be disposed in portions of the lubricant feed pipe 13 where the flow of the lubricant is changed. To detect the lubricant flow sensitively, it is preferable to dispose the detection member 6 in the vicinity of the outlet upstream in the lubricant feed pipe 13.

In place of the elbow 23, a bend may be used as the pipe joint. The angle of the elbow 23 and the bend is not limited to 90 degrees, but may be any angle.

FIG. 20 is a sectional view of the structure of a lubricant-feed-state monitoring sensor.

This lubricant-feed-state monitoring sensor has the same structure as that of another of the sensors except that a strain detecting element is used as the detection member 6 in place of the piezo element 8.

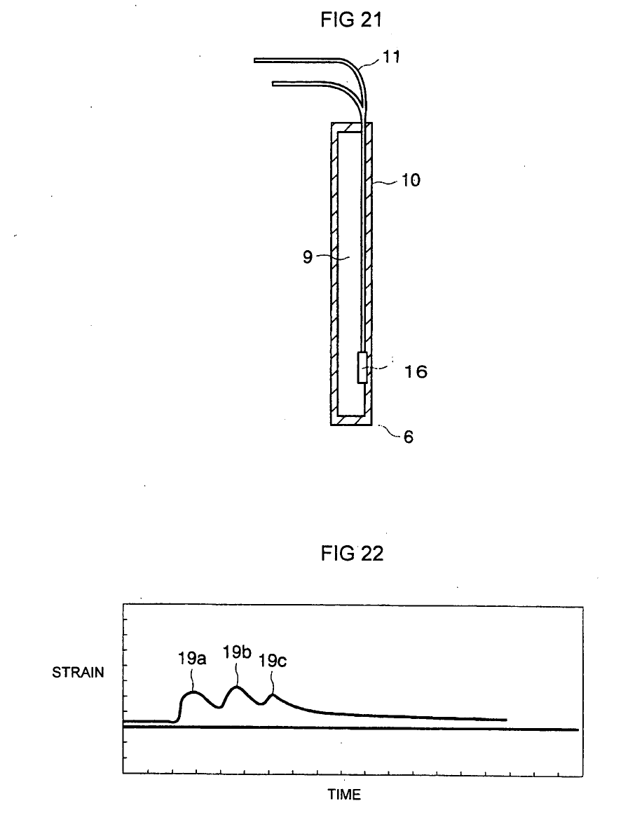

FIG. 21 is a sectional view of the detection member 6 viewed from the side.

The detection member 6 has a strain gauge 16 as a strain detecting element, in which the strain gauge is bonded to the reinforcing plate 9, the whole of which is covered with the elastic coating member 10. The strain gauge 16 is connected to the lead 11 via an electrode at the end thereof by soldering or the like.

The reinforcing plate 9 may be made of any material that can generate strain by a given bending deflection, e.g., metal such as iron, or polymeric materials such as plastic.

The strain gauge 16 may be bonded not only one side of the reinforcing plate 9 but also to both sides. A dummy gauge may also be used to compensate changes in temperature. Known various strain measuring methods may be used to measure normal strain.

When lubricant is fed to the lubricant-feed-state monitoring sensor connected to the lubricant feed pipe 13, the lubricant flows in the direction of the arrow in FIG. 20. Then the detection member 6 is bent downstream, with the portion fixed with the resin 7 as the fulcrum. As a result, the element wire of the strain gauge 16 is deflected to change in resistance. The change in resistance is sensed as a change in voltage by a Wheatstone bridge circuit (not shown), allowing measurement of amount of strain.

FIG. 22 shows the waveform output from the lubricant-feed-state monitoring sensor using the strain detecting element.

The axis of ordinate indicates the amount of strain, and the axis of abscissa indicates elapsed time from the left to the right. Three angular strain waveforms 19a, 19b, and 19c are formed by the bending strain caused by three times of intermittent pressure flow of lubricant acting on the detection member 6. When the flow of lubricant stops, the detection member 6 recovers to the initial state by the elastic force of the reinforcing plate 9. As a result, the strain is going to recover to the initial state. In this way, the intermittent lubricant flow forms the angular strain waveforms with little noise.

The reason the waveform of FIG. 22 has the continuous angular strain waveforms is that it takes much time to recover to the initial state by the elastic force of the reinforcing plate 9. When the reinforcing plate 9 is made of a high-elasticity material, this phenomenon does not occur. However, this phenomenon presents no problem for an automatic central lubrication device that feeds lubricant every several hours.

The drawbacks of the strain gauge 16 include the drift of the zero point when lubricant changes in temperature. This problem can be solved by signal processing by applying the above-mentioned temperature compensation or using a high-pass filter.

The lubricant-feed-state monitoring sensor has such a simple structure that uses the strain gauge 16 as the detection member 6. Accordingly, a compact and low-price lubricant-feed-state monitoring sensor can be provided as compared with that having a pressure sensor.

The structure of a lubricant-feed-state monitoring device will be described having the function of counting the number of feedings of lubricant to determine the lubricant feed state, in addition to the above-described functions.

FIG. 7 is a schematic diagram of the lubricant-feed-state monitoring device. When the lubricant-feed-state monitoring sensor shown in FIG. 13 is used as a modification of another of the structures, the counter unit 25 may connect directly to the T-shaped pipe joint 2.

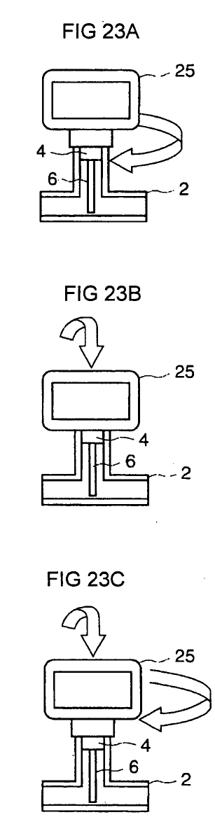

FIGS. 23A, 23B, and 23C are simplified sectional views of a lubricant-feed-state monitoring device.

The lubricant-feed-state monitoring device shown in FIGS. 23A, 23B, and 23C has a structure in which the counter unit 25 is rotatably mounted on the lubricant-feed-state monitoring device of FIG. 7.

Specifically, FIG. 23A shows a structure in which the counter unit 25 is rotatable about a longitudinal axis of the detection member 6. FIG. 23B shows a structure in which the counter unit 25 is rotatable about an axis perpendicular to the face on which the detector 6 receives the dynamic pressure of lubricant. FIG. 23C shows a structure in which the counter unit 25 is rotatable about the center axes in FIGS. 23A and 23B.

The counter unit 25 can be rotated at an appropriate angle irrespective of the state of the installation of the lubricant-feed-state monitoring device. Accordingly, the reader can easily read the count without the need to change his/her position.

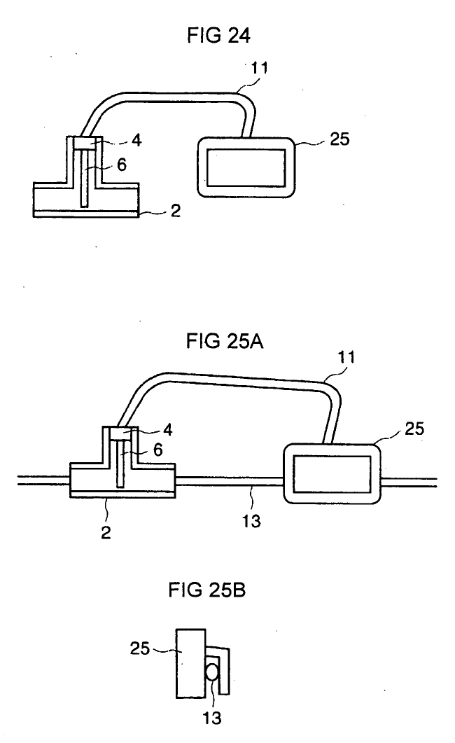

FIG. 24 is a simplified sectional view of a lubricant-feed-state monitoring device.

The lubricant-feed-state monitoring device of FIG. 24 has a structure in which the counter unit 25 is mounted detachably to the T-shaped pipe joint 2 or the nipple 3 in the lubricant-feed-state monitoring device of FIG. 7, and the detection member 6 and the counter unit 25 are connected via the lead 11. To allow the counter unit 25 to be detachable, the counter unit 25 has a clamping mechanism or an attracting mechanism.

FIGS. 25A and 25B show a state in which the counter unit 25 is mounted to the lubricant feed pipe 13. FIG. 25A is a front view of the mounted state; and FIG. 25B is a sectional view of the mounted state. The counter unit 25 can be mounted to the lubricant feed pipe 13 with a clamping mechanism 34. Using a clip or the like for the clamping mechanism 34 can reduce the cost.

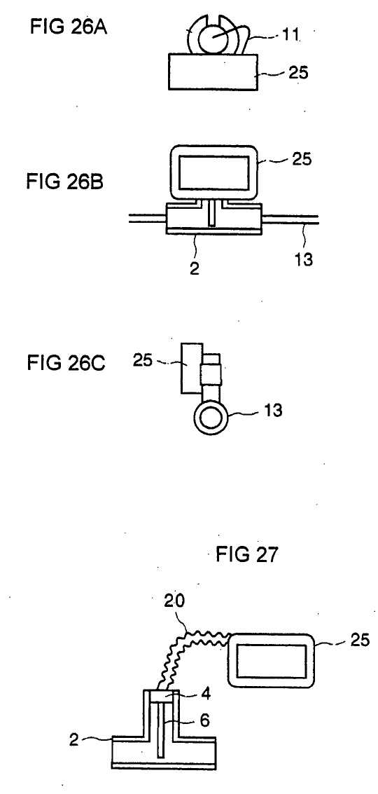

FIGS. 26A, 26B, and 26C show a state in which the counter unit 25 is mounted on the T-shaped pipe joint 2. FIG. 26A is a top view of the mounted state; FIG. 26B is a front view of the mounted state; and FIG. 26C is a side view of the mounted state. The counter unit 25 can be mounted on the T-shaped pipe joint 2 or the nipple 3 with the clamping mechanism 34.

According to the structure of FIG. 24, even if the detection member 6 or the like is mounted at a position that is difficult to access in operation for safety reasons, the count value can be read from a remote place in safety. The detachable structure of the counter unit 25 can simplify the joint portion structure of the lubricant-feed-state monitoring device, decreasing the cost. While this embodiment has been described for the structure using the clamping mechanism 34, the invention is not limited to that, but the counter unit 25 may be demounted with an attracting mechanism using a magnet or the like so as to be detached.

FIG. 27 is a simplified sectional view of the structure of a lubricant-feed-state monitoring device.

The lubricant-feed-state monitoring device of FIG. 27 has a structure in which the detection member 6 and the counter unit 25 of the lubricant-feed-state monitoring device of FIG. 7 are connected to each other with a flexible tube 20. The flexible tube 20 is made of a material or structure that can be expanded and contracted by applying force to the counter unit 25, and after the force is eliminated, that can be maintained in shape.

The counter unit 25 can easily be moved to an appropriate position. Thus the count value can easily be read, improving the efficiency of checking and monitoring operations. The counter unit 25 may have the clamping mechanism or the attracting mechanism.

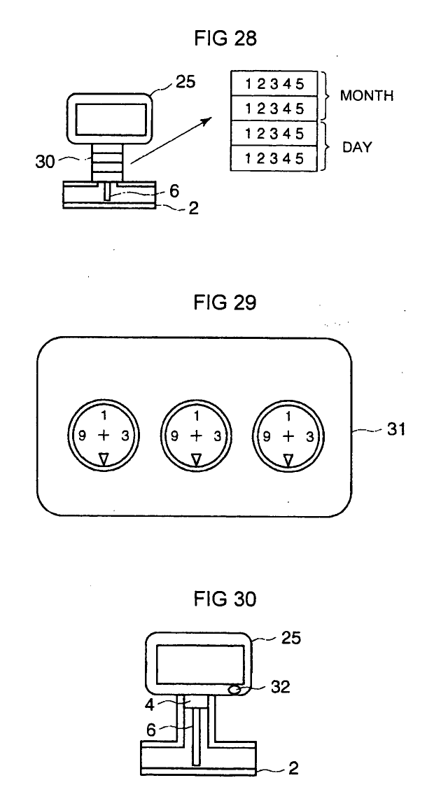

FIG. 28 is a simplified sectional view of the structure of a lubricant-feed-state monitoring device.

The lubricant-feed-state monitoring device of FIG. 28 has a date setting mechanism capable of setting and displaying date in the lubricant-feed-state monitoring device of FIG. 7.

To determine whether lubricant is being normally fed, it is necessary to read the count in a given period of time. Thus, by the structure in which the date at which the counter is reset, i.e., the base date, is set and displayed on the lubricant-feed-state monitoring device, it can directly be determined locally whether the lubricant feed state is normal.

While this structure has a rotary date setting device 30 for setting date by rotating rotational rings on which figures are displayed, as a date setting mechanism. Alternatively, a rotary date setting device 31 shown in FIG. 29 may be provided in which date is set by rotating discs on which figure are displayed. With a structure in which the rotary date setting device 33 is disposed on the back of the counter unit 25 to allow the checker to set date with a cross slot screwdriver, the lubricant-feed-state monitoring device can be made compact.

FIG. 30 is a simplified sectional view of the structure of a lubricant-feed-state monitoring device.

The lubricant-feed-state monitoring device of FIG. 30 includes a reset switch 32 for resetting the count value on the counter unit 25 of the lubricant-feed-state monitoring device of FIG. 7.

It is necessary to read the count in a given period of time to determine whether lubricant is being normally fed. Accordingly, when the counter of the counter reset switch 32 disposed on the lubricant-feed-state monitoring device is reset at checking, a normal count at the next checking can be grasped. This allows immediate local determination whether lubricant is being fed normally.

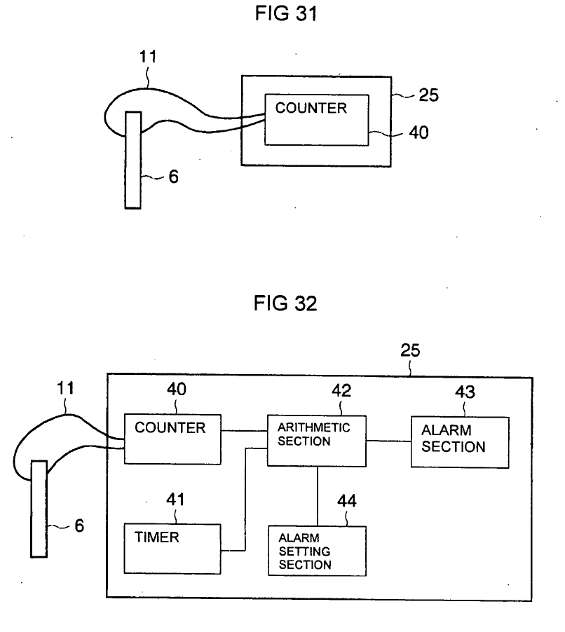

FIG. 31 is a block diagram of a counter unit 25 of a lubricant-feed-state monitoring device.

The signal from the detection member 6 is input to the counter unit 25 via the lead 11. The counter unit 25 includes a counter 40 having only the function of counting the number of feedings of lubricant and displaying the value. FIG. 31 does not show the counter reset function.

The lubricant-feed-state monitoring device of this structure is a detection member having a minimum structure, so that it can be reduced in size and cost.

FIG. 32 is a block diagram of a counter unit 25 of a lubricant-feed-state monitoring device.

The counter unit 25 of FIG. 32 includes the counter 40, a timer 41, an arithmetic section 42, an alarm section 43, and an alarm setting section 44.

The arithmetic section 42 determines whether a specified amount or more of lubricant has been fed in a given period of time, from the number of feedings of lubricant which is counted by the counter 40 and the time information of the timer 41. When the number of feedings in the period of time of the timer is smaller than a set value, that is, when no or a little lubricant has been fed in a given period of time, the alarm section 43 outputs an alarm. The threshold for outputting the alarm, or the set value of the times of feedings is set by the alarm setting section 44.

The lubricant-feed-state monitoring device of FIG. 32 can monitor and alarm failure in lubricant feeding with a relatively compact device. The components (40 to 44) constituting the counter unit 25 may either be integrated to one or be separated appropriately from one another and connected through a signal line.

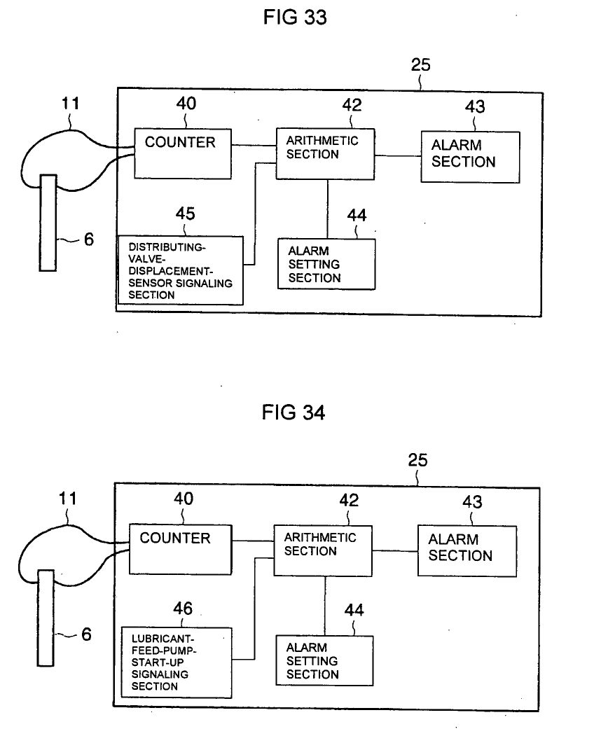

FIG. 33 is a block diagram of a counter unit 25 of a lubricant-feed-state monitoring device. The components having the functions of FIG. 32 are given the same numerals and their detailed description will be omitted.

The counter unit 25 of FIG. 33 is different from that of the foregoing structure in that it has a distributing-valve-displacement-sensor signaling section 45 in place of the timer 41. A distributing-valve-displacement sensor (not shown) detects the operation of the distributing valve 12, and the distributing-valve-displacement-sensor signaling section 45 takes in the operation timing as a lubricant feed timing. When the count of the counter 40 does not increase in a given period of time after the distributing valve 12 has been activated, the arithmetic section 42 determines that the feeding of lubricant is faulty, and the alarm section 43 alarms of it. The alarm setting section 44 sets the time for the determination of the arithmetic section 42.

The lubricant-feed-state monitoring device of FIG. 33 includes the distributing-valve-displacement-sensor signaling section 45 in place of the timer 41 of FIG. 32, with which it detects the displacement of the distributing valve to grasp the timing at which the distributing valve 12 is activated, thus monitoring the lubricant feed state. Accordingly, it can detect abnormality faster than using the timer 41.

FIG. 34 is a block diagram of the structure of a counter unit 25 of a lubricant-feed-state monitoring device. The components having the same functions as FIG. 32 are given the same numerals and their detailed description will be omitted.

The counter unit 25 of FIG. 34 is different from that of the structure of FIG. 32 in that it has a lubricant-feed-pump-start-up signaling section 46 in place of the timer 41.

An automatic central lubrication control device (not shown) outputs a lubricant-feed-pump start-up signal. The lubricant-feed-pump-start-up signaling section 46 takes in the timing at which the lubricant-feed-pump start-up signal is turned on as the timing to feed lubricant. When the count of the counter 40 does not increase in a given period of time after the lubricant-feed-pump start-up signal has been turned on, the arithmetic section 42 determines that the feeding of lubricant is faulty, and the alarm section 43 alarms of it. The alarm setting section 44 sets the time for the determination of the arithmetic section 42.

The lubricant-feed-state monitoring device of FIG. 34 has the lubricant-feed-pump-start-up signaling section 46 in place of the timer 41 of FIG. 32, with which it detects the ON state of the lubricant-feed-pump start-up signal to monitor the lubricant feed state. Accordingly, it can detect abnormality faster than using the timer 41.

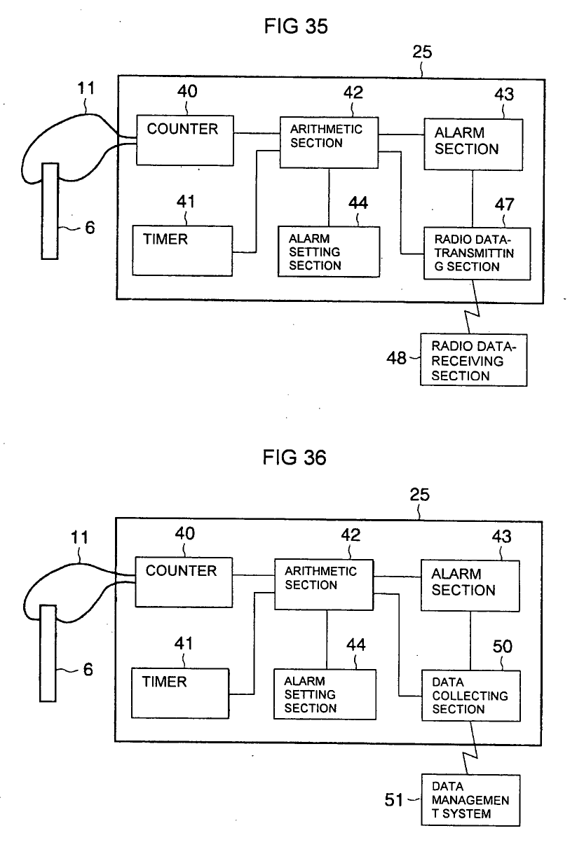

FIG. 35 is a block diagram of the structure of a counter unit 25 of a lubricant-feed-state monitoring device. The components having the same functions as FIG. 32 are given the same numerals and their detailed description will be omitted.

The counter unit 25 of FIG. 35 is different from that of the structure of FIG. 32 in that it has a radio data-transmitting section 47 in addition to the structure of the counter unit 25 of FIG. 32.

The radio data-transmitting section 47 transmits at least one of signals indicative of the count, the result of determination on lubricant feed state, the alarm output to a radio data-receiving section 48. The timing of transmission may either be periodic or at the time a data transmission request is given from the exterior.

With the lubricant-feed-state monitoring device of FIG. 35, the user can collect data on the lubricant feed state of facilities that are difficult to access in operation for safety reasons and monitor it.

FIG. 36 is a block diagram of the structure of a counter unit 25 of a lubricant-feed-state monitoring device. The components having the same functions as FIG. 32 are given the same numerals and their detailed description will be omitted.

The counter unit 25 of FIG. 36 is different from that of the structure in FIG. 32 in that it has a data collecting section 50 in addition to the structure of the counter unit 25 of FIG. 32.

The lubricant-feed-state monitoring device of FIG. 36 is configured as an online monitoring system. Specifically, the data collecting section 50 transmits data on the lubricant feed state to a data management system 51 via a communication line such as cable, radio, telephone line, and LAN.

This structure allows centralized continuous monitoring of the lubricant feed state of particularly important facilities by remote control. The online monitoring is not limited to the configuration shown in FIG. 36, but may be a combination with the foregoing structure, in which the date generated in the structure is sent to the data management system 51 via the data collecting section 50, and monitored.

The alarm section 43 may be constructed using various systems. For example, for light alarms, the lubricant-feed-state monitoring device may have either a light-emitting diode or a Patlite (registered trademark) that flashes at remote sites.

For sound alarms, the lubricant-feed-state monitoring device may have a speaker, or alternatively, sound may be output via a separate sound alarm section disposed in a remote operator's cabin or maintenance section.

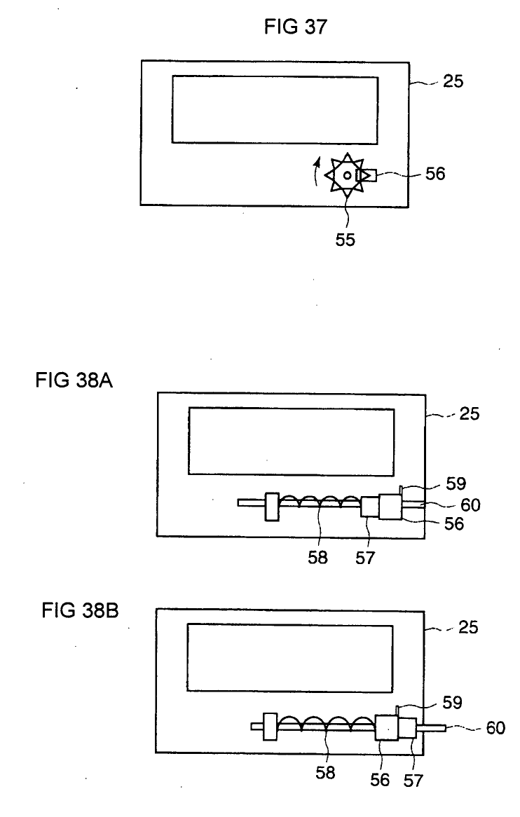

For display alarms, either an electronic display or mechanically switching display may be provided. For example, as shown in FIG. 37, the counter unit 25 may include a rotary disc 55 that is color-coded in normal and abnormal conditions, and the lubricant feed state can be viewed through an alarm display window 56.

As shown in FIG. 38A, the counter unit 25 may have a flat plate 57 that is color-coded in normal and abnormal conditions, which is pushed to a pin 59 with a spring 58. In emergency, the pin 59 is released to move the flat plate 57 so that the lubricant feed state is viewed through the alarm display window 56, as shown in FIG. 38B. After the alarm is displayed, the display can be returned to the initial state by pushing a rod 60.

The use of the lubricant-feed-state monitoring devices according to the foregoing structure allows monitoring whether a necessary amount of lubricant has been fed to facilities such as rotary machines under various conditions. Combining the lubricant-feed-state monitoring devices with the components and devices of the foregoing embodiments provides lubricant-feed-state monitoring devices having new functions. This allows provision of lubricant-feed-state monitoring devices with functions necessary and sufficient to prevent initial abnormality of various facilities due to imperfect lubricant feeding.

The lubricant-feed-state monitoring devices can be applied not only to grease but to oil.

Since the foregoing structures have various steps, various advances can be taken out through appropriate combination of the plurality of disclosed components. For example, even if some of all the components of the structure is eliminated, a structure without the components can be extracted provided that the problems to be solved can be solved and the advantages can be offered.

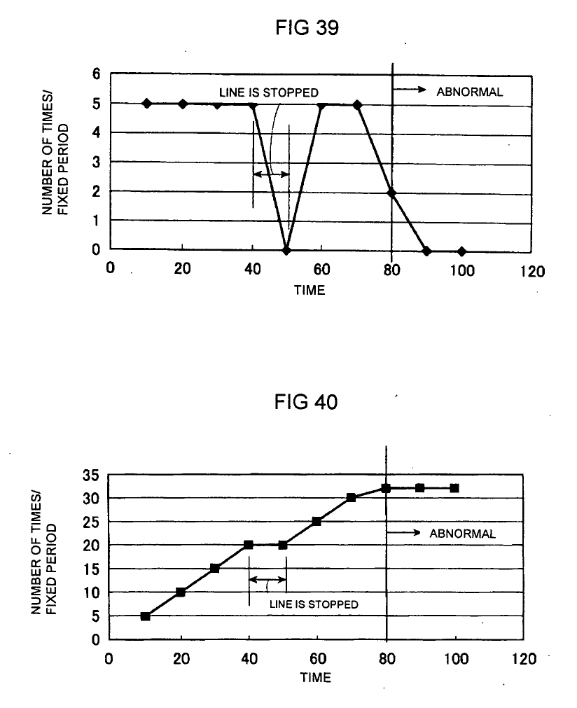

FIG. 39 is a graph of a method of monitoring a lubricant feed state. When the number of feedings of lubricant falls below a predetermined number in a predetermined period of time, it is determined that the lubricant feed state is abnormal.

In the example of FIG. 39, the number of lubricant feedings in a predetermined period of time was one per two hours (five per ten hours). Specifically, the number of feedings was normal, one per two hours (five per ten hours), until 40 hours; the number decreased to zero per hour from 40 through 50 hours, and increased again to a normal number, one per two hours from 50 through 60 hours. The number of lubricant feedings from 40 through 60 hours fell below the predetermined number in a fixed time. This is because the line of the apparatus to be lubricated stopped.

The number of feedings returned to normal, one per two hours, from 60 through 70 hours, but fell below the predetermined number at 80 hours. Accordingly, it was determined that the lubricant feed state was abnormal. FIG. 40 is a graph in which the changes in number of lubricant feedings in a predetermined period of time shown in FIG. 39 were replaced with the cumulative numbers of lubricant feedings. FIG. 40 also allows the lubricant feed state to be monitored, as in FIG. 39.

Specifically, the graph in FIG. 40 had a straight line with a constant slope (the number of lubricant feedings per hour) from zero through 40 hours, and when the line of the apparatus that needs to be fed with lubricant was stopped from 40 through 50 hours, the graph temporarily had a horizontal line. Then the graph from 50 through 70 hours had a straight line with the same slope as that from zero through 40 hours. The slope angle decreased from 80 hours. Thus, it was determined that the lubricant feed state was abnormal.

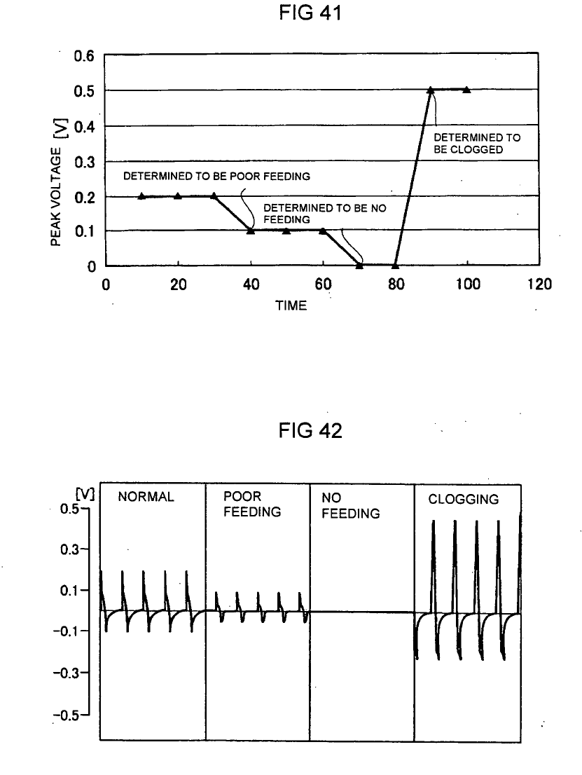

FIG. 41 is a graph of a method of monitoring a lubricant feed state. The graph shows an example of changes in the peak voltage of sensor output with time which were measured using a peak hold circuit. When a sensor output waveform is input to an oscilloscope or another analyzer having a peak hold function, the peak voltage of the sensor output can easily be provided. The peak voltage of the sensor output is measured from a sensor output waveform by peak hold processing, and when the peak voltage comes out of a predetermined range, it is determined that the lubricant feed state is abnormal. Specifically, a lower threshold and an upper threshold are set for peak voltage. When the peak voltage becomes smaller than the lower threshold, it can be determined that the amount of lubricant has decreased or stopped; when the peak voltage has exceeded the upper threshold, it can be determined that lubricant has clogged downstream of the sensor. In the example of FIG. 41, the lower threshold of peak voltage set on the basis of a measured initial voltage was 0.15 V, and the upper threshold was 0.4 V.

To reduce the data sampling cycle, it is preferable to set the lower threshold and the upper threshold of the peak voltage in consideration of the possibility of slight variations in peak hold processing.

In the example of FIG. 41, the lubricant feed state was normal with the peak voltage of 0.2 V until 30 hours, but it fell below the lower threshold 0.15V to reach 0.1 V at 40 hours, so that it was determined that lubricant feed state was poor. The peak voltage 0.1 V continued from 40 through 60 hours. The peak voltage further fell to zero at 70 hours, so that it was determined that no lubricant was being fed. The peak voltage rose sharply at 90 hours to exceed the upper threshold 0.4 V to reach 0.5V, so that it was determined that the part downstream from the sensor had clogged. This is because when the part downstream from the sensor clogs, the pressure at the sensor increases to apply a large force to the piezo element or the strain gauge, thus increasing the peak voltage.

The lubricant feed state can also be determined easily, without the peak hold processing, by visually measuring peak-to-peak voltage on the screen of an oscilloscope to determine a peak voltage, although it may include a slight error.

FIG. 42 shows a test screen of an oscilloscope on which a waveform output from a sensor is displayed. It shows four different lubricant feed states, normal, short, no lubricant, and clogging downstream from the sensor, from the left to right of the graph. FIG. 42 shows the results of a test in which lubricant is fed at intervals of one second, with the different states for five seconds each.

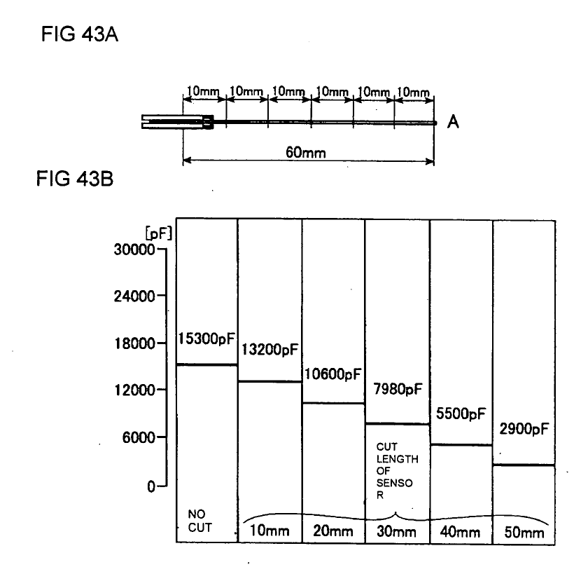

FIG. 43B shows the results of an experiment in which the sensor part member 6 of the lubricant-feed-state monitoring device that uses a piezo element, shown in FIGS. 1, 13, and 14, was cut at 10 mm intervals from the distal end A, and the capacitances from 0 mm (not cut) to 50 mm in cut length were measured using a capacitance level meter.

FIG. 43B shows that the capacitance was 15,300 pF when the sensor has not been cut (the initial value), while the capacitance was 13,200 pF when the sensor was cut by 10 mm from the distal end, and finally, it reduced significantly to 2,900 pF when the sensor was cut by 50 mm from the distal end. In other words, the length of the piezo element and the capacitance were approximately in proportion to each other.

Abnormality of sensors using a piezo element is generally caused by the breakage of the vicinity of the fixing portion of the sensor due to the bending stress of lubricant, in which case the capacitance of the sensor is reduced significantly, facilitating determination whether the sensor fixing portion is broken.

Thus, when abnormality was detected in the examples of FIGS. 39 to 42 after the monitoring of lubricant feed state has been started, the capacitance of the sensor is measured, and when the capacitance is smaller than a predetermined threshold, it is determined that the sensor is abnormal, so that abnormality owing to the abnormal sensor can be removed from the determination on abnormality based on the count of lubricant feedings or the determination on abnormality based on the peak voltage. In the example of FIG. 43B, the threshold was preset to 12,000 pF in consideration of the breakage of the sensor by 10 mm from the distal end.

Specifically, the method of monitoring the lubricant feed state, shown in FIGS. 39 to 42, allows determination on the abnormality of the lubricant feed state. However, the experimental results shown in FIG. 43B shows that when a piezo element, or a piezoelectric element, is used as a sensor, determination on abnormality based on the count of lubricant feedings or the determination on abnormality based on the peak voltage can easily be corrected by measuring the capacitance of the sensor even if the apparent lubricant feed state is abnormal. Briefly, abnormality due to the abnormality of the sensor can advantageously be eliminated from those determinations on abnormality.

With the lubricant-feed-state monitoring device using the strain gauge as the sensor, as shown in FIG. 20, a break of the strain gauge can be checked by measuring the insulation resistance of the strain gauge. Measuring static strain allows determination whether the strain gauge is normal.

The structure may be applied not only to an automatic feeding unit for feeding bearings etc. with lubricant such as grease, but also to a manual feeding unit.

### INDUSTRIAL APPLICABILITY

The feed state of lubricant to lubricating points can reliably be monitored at low cost in the vicinity of the lubricating points, allowing application to various necessary portions to be lubricated, such as bearings of rotary machines. This allows imperfect lubrication to be found early, thus preventing troubles.

1-34. (canceled)

35. A lubricant-feed-state monitoring sensor disposed directly associated with a device fed with oily or fatty lubricant or a lubricant feed pipe for feeding lubricant to the device, for monitoring the feed state of lubricant by detecting the supply of the lubricant to the device, the sensor comprising a T-shaped member having a lubricant passage connected to the lubricant feed pipe and a detector insertion portion extending substantially vertically from a middle portion of the lubricant passage, into which a detector is inserted; wherein the detector is disposed such that a first end portion of the detector is fixed to a top portion of the detector insertion portion, and a second end portion is positioned in the lubricant passage without restraint, the detector undergoing bending deflection by displacement of the second end portion due to the flow of the lubricant, and the detector having a piezoelectric element that generates voltage by the bending deflection.

36. The sensor according to claim 35, wherein the detector further comprises a heat shrinkable film made of a flexible material that coats the piezoelectric element.

37. A method of monitoring a feed state of lubricant to a device fed with lubricant with a sensor mounted to the device or a lubricant feed pipe connected to the device comprising:
disposing the sensor to undergo bending deflection by lubricant flow when the lubricant is fed;
converting strain generated by the sensor due to the bending deflection to an electrical signal;
measuring peak voltage of the electrical signal by peak hold processing; and
when the peak voltage is in a predetermined range, determining that the lubricant feed state is abnormal.

38. The method according to claim 37, wherein a lower threshold and an upper threshold are set for the peak voltage in advance; and when the peak voltage falls below the lower threshold, determining that the amount of lubricant has decreased or stopped, and when the peak voltage exceeds the upper threshold, determining that the part downstream from the sensor is clogged.

39. The method according to claim 37, wherein, when the sensor is a piezoelectric element, capacitance of the sensor is measured after monitoring of the lubricant feed state has been started, and when the capacitance of the sensor is less than a predetermined threshold, determining that the sensor is abnormal, and abnormality due to the abnormal sensor is removed from the determination on abnormality of feed state of lubricant based on the peak voltage, on the basis of the determination on the sensor abnormality.

40. The method according to claim 38, wherein, when the sensor is a piezoelectric element, capacitance of the sensor is measured after monitoring of the lubricant feed state has been started, and when the capacitance of the sensor is less than a predetermined threshold, determining that the sensor is abnormal, and abnormality due to the abnormal sensor is removed from the determination on abnormality of feed state of lubricant based on the peak voltage, on the basis of the determination on the sensor abnormality.
